(19) United States
(12) Patent Application Publication
(10) Pub. No.: US 2015/0230418 A1
(43) Pub. Date: Aug. 20, 2015

(54) SYSTEMS AND METHODS FOR RFID COMMUNICATION IN LANDSCAPE CONTROLLER WITH FEATURE MODULE

(71) Applicant: Hunter Industries, Inc., San Marcos, CA (US)

(72) Inventors: Peter John Woytowitz, San Diego, CA (US); LaMonte D. Porter, San Marcos, CA (US)

(21) Appl. No.: 14/702,466

(22) Filed: May 1, 2015

Related U.S. Application Data
(63) Continuation-in-part of application No. 13/708,577, filed on Dec. 7, 2012.
Application No. 13/708,577 is a continuation-in-part of application No. 13/091,645, filed on Apr. 21, 2011, now Pat. No. 8,977,400.
Application No. 13/091,645 is a division of application No. 12/243,897, filed on Oct. 1, 2008, now Pat. No. 7,953,517.

(51) Int. Cl. A01G 25/16; G05B 15/02; G06K 7/10

(52) U.S. Cl. CPC A01G 25/16; G06K 7/10366; G05B 15/02

(57) ABSTRACT

A feature module includes an RFID tag and a landscape controller includes an RFID reader. The RFID reader provides communication between the feature module and the processor of the landscape controller to provide additional functionality such as feature unlocking, user privileges, new features, module identification, module inventory, and health/history log.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field of the Invention

The present invention relates to residential and commercial irrigation systems used with turf and landscaping, and more particularly to irrigation controllers that execute watering schedules and other landscape related functions in accordance with an operational program.

2. Description of the Related Art

Electronic irrigation controllers have long been used on residential and commercial irrigation sites to water turf and landscaping. They typically comprise a plastic housing that encloses circuitry including a processor that executes a watering program. Watering schedules are typically manually entered or selected by a user with pushbutton and/or rotary controls while observing an LCD display. The processor turns a plurality of solenoid actuated valves ON and OFF with solid-state switches in accordance with the watering schedules that are carried out by the watering program. The valves deliver water to sprinklers connected by subterranean pipes.

Irrigation controllers are manufactured with a wide range of sizes and features. Large irrigation controllers are typically used in commercial applications, golf courses, playing fields, and parks. Large irrigation controllers have the capability of watering many zones, e.g. fifty zones or more, and sometimes have sophisticated features not found in smaller irrigation controllers used in residential applications. For example, large irrigation controllers may have built-in capability for turning sprinklers on and off to optimize the flow of water through the irrigation pipes while meeting the irrigation requirements of the property

The features provided by irrigation controllers continue to evolve to accommodate more complex landscapes and continuously developing strategies to manage water and energy more effectively. Irrigation controllers used in the professional market place tend to be relatively expensive and labor intensive to replace as new features are introduced. There is a growing need to provide different features on different sites. From a cost standpoint, homeowners and professionals do not want to pay for features they do not require. There is also a need to develop irrigation controllers that meet multiple needs of a landscaped property besides just irrigating plants.

At the present time homeowners and professionals can only purchase irrigation controllers with the capability of adding station modules to increase the number of zones, but without feature upgrade capability. This forces distributors to stock a wide range of irrigation controllers, which adds the cost of carrying a large inventory of different types of irrigation controllers. Moreover, as the irrigation needs of a particular landscape site change and/or as government imposes more water usage restrictions, homeowners and professionals are sometimes forced to buy entirely new irrigation controllers.

### SUMMARY

In accordance with the present invention, a landscape controller includes a housing and a control panel on the housing. The control panel includes a display and at least one manual control that enable a user to enter and/or select a watering schedule. A memory is provided for storing an operational program for carrying out the watering schedule. A processor is connected to the memory and is capable of executing the operational program. A connecting device in the control panel operatively connects at least one feature module to the processor. The controller further includes station control circuitry controlled by the processor that enables the processor to selectively energize a plurality of valves to deliver water to sprinklers in accordance with the watering schedule.

A landscape irrigation system includes an irrigation controller, an RFID tag, and an RFID tag reader. The RFID tag comprises information to modify the operation of the irrigation controller. When the RFID tag is near the RFID tag reader, the RFID tag reader reads the information from the RFID tag and communicates the information to the irrigation controller. The information may include features that are not available without the information.

In an embodiment, the RFID tag is placed inside the irrigation controller. In another embodiment, a feature module comprises the RFID tag and a holder configured to support the RFID tag. In an embodiment, the feature module is inserted into a slot in the control panel of the irrigation controller. In another embodiment, the holder is formed in the door of the irrigation controller. In another embodiment, the holder is formed in the controller housing. In another embodiment, the feature module is carried by an operator and allows the operator access to the features which are not available to others.

Certain embodiments relate to an irrigation system comprising a back plane housed by a housing, a control panel mounted to the housing and configured to enable a user to enter and/or select a watering schedule, where the control panel comprises a memory configured to store an operational program that implements the watering schedule and a processor configured to execute the operational program, at least one feature module configured to provide additional functionality not available without the at least one feature module, where the at least one feature module comprises a radio frequency identification (RFID) tag configured to provide tag information, an RFID tag reader configured to read the RFID tag and to communicate the tag information to the processor, where based at least in part on the tag information, the processor implements the additional functionality, and station control circuitry configured to selectively energize a plurality of valves to deliver water to sprinklers according to the watering schedule, where the station control circuitry is further configured to be removably insertable on the back plane.

In an embodiment, the processor controls the RDIF tag reader. In another embodiment, the reader periodically reads the RFID tag to determine whether the feature module has been removed from a reading range of the RFID tag reader. In a further embodiment, the RFID tag comprises memory that stores the tag information. In a yet further embodiment, the tag information comprises executable code configured to be executed by the processor.

In an embodiment, the tag information comprises authentication information to authenticate the feature module. In another embodiment, the RFID tag reader is further configured to query one or more RFID tags associated with the control panel, and based at least in part on the responses returned from the one or more RFID tags, the processor determines types of the feature modules. In a further embodiment, the RFID tag comprises read/write memory and the RFID tag reader is configured to send data to the RFID tag to be stored in the read/write memory. In a yet further embodiment, the data comprises use information about a use of the at least one feature module.

Other embodiments relate to a method to control a plurality of valves on an irrigation site. The method comprises accepting inputs on a control panel from a user that enable the user to enter a watering schedule, storing the watering schedule in memory that is operatively connected to a processor configured to execute the watering schedule, providing a feature module that comprises a radio frequency identification (RFID) tag and a housing configured to house the RFID tag, where the feature module is configured to provide additional functionality not available without the feature module, reading the RFID tag to obtain tag information, determining, based on the tag information, whether to access the additional functionality provided by the feature module, and selectively turning a power signal ON to a plurality of valves that deliver water to a plurality of sprinklers located on an irrigation site according to the watering schedule.

In an embodiment, reading the RFID tag comprises reading the RFID tag with an RFID tag reader when the RFID tag is within a reading range of the RFID tag reader. In another embodiment, the method further comprises communicating the tag information to the processor. In a further embodiment, the processor and the RFID tag reader communicate over a serial peripheral interface (SPI) connection. In a yet further embodiment, the additional functionality comprises one or more of a feature unlocking function, a user privilege, a new feature enablement function, a module authentication function, a module inventory function, and a health/history log.

Certain embodiments relate to a landscape controller comprising a housing, a control panel associated with the housing and including at least one manual control that enables a user to enter and/or select a watering schedule, a memory storing an operational program to implement the watering schedule, a processor configured to execute the operational program, a radio frequency identification (RFID) tag reader configured to read tag information from an RFID tag when the RFID tag is near the RFID tag reader, where the RFID tag is associated with a feature module that provides additional functionality not available without the feature module. The RFID tag reader is further configured to communicate the tag information to the processor, where based at least in part on the tag information, the processor accesses the additional functionality provided by the feature module. The landscape controller further comprises station control circuitry controlled by the processor that enables the processor to selectively energize a plurality of valves to deliver water to sprinklers according to the watering schedule.

In an embodiment, the operational program includes a set of features capable of being executed by the processor and the additional functionality of the feature module enables a sub-set of the set of features. In another embodiment, the feature module further comprises additional memory that enables the processor to execute at least one feature when the additional functionality is accessed that is otherwise not executable by the processor. In a further embodiment, the operational program comprises at least one locked irrigation feature. In a yet further embodiment, the processor is configured to unlock the at least one locked irrigation feature based at least in part on the tag information. In another embodiment, the station control circuitry comprises an encoder that transmits operational instruction to decoders that are installed outside of the landscape controller.

### BRIEF DESCRIPTION OF THE DRAWINGS

Throughout the drawings, reference numbers are re-used to indicate correspondence between referenced elements. The drawings, associated descriptions, and specific implementation are provided to illustrate embodiments and not to limit the scope of the disclosure.

FIG. 1 is a front elevation view of a landscape controller in accordance with an embodiment of the present with its front door open to reveal its removable face pack.

FIG. 2 is a front elevation view of the landscape controller of FIG. 1 with its face pack carrying frame swung open to reveal the screw type wire connectors and other components mounted in its rear panel.

FIG. 3A is an isometric view of the face pack of the landscape controller of FIG. 1 removed from the frame and rear housing and with a single feature module plugged into the left slot in its lower edge.

FIG. 3B is view of the face pack of the landscape controller of FIG. 1 showing the feature module removed from its slot.

FIG. 4 is a block diagram of the landscape controller of FIG. 1.

FIG. 5 is a block diagram of the landscape controller of FIG. 1 connected to a feature module with a serial memory.

FIG. 6 is a flow diagram illustrating a method of writing a byte of data to the serial memory chip inside the feature module of FIG. 5.

FIG. 7 is flow diagram illustrating a method of reading a byte of data from the serial memory chip inside the feature module of FIG. 5.

FIG. 8 is a block diagram of the landscape controller of FIG. 1 connected to a feature module with a parallel memory.

FIG. 9 is a flow diagram illustrating a method of writing a byte of data to the parallel memory chip inside the feature module of FIG. 8.

FIG. 10 is flow diagram illustrating a method of reading a byte of data from the parallel memory chip inside the feature module of FIG. 8.

FIG. 11 is a block diagram of a feature module configured like a USB thumb drive.

FIG. 12 is a block diagram of a feature module that includes a microcontroller.

FIG. 13 is a block diagram of a feature module that incorporates an asynchronous communications channel.

FIG. 14 is a flow diagram illustrating a method of unlocking features preprogrammed into the face pack of the landscape controller of FIG. 1.

FIG. 15 is a block diagram of a robust feature module.

FIG. 16 is a block diagram of a feature module that enables wireless communication between the landscape controller of FIG. 1 and external devices such as environmental sensors.

FIG. 17 is a block diagram of a feature module that utilizes a standard SD card as the memory device for retaining information.

FIG. 18 is a block diagram of a controller that uses an SD card as a feature module.

FIG. 19 is a flow diagram illustrating a method of writing data to the SD card of FIG. 17.

FIG. 20 is flow diagram illustrating a method of reading data from the SD card of FIG. 17.

FIG. 21 is an isometric view of a pedestal style landscape controller taken from the front thereof in accordance with further embodiment of the present invention.

FIG. 22 is view similar to FIG. 21 with the door and front panel of the landscape controller removed to reveal its face pack, screw-type wire connectors, and other components mounted in its back panel.

FIG. 23 is an enlarged front isometric view of the face pack of the landscape controller of FIG. 21.

FIG. 24 is an enlarged rear isometric view of the face pack of the landscape controller of FIG. 1 showing its SD card slot.

FIG. 25 is a block diagram illustrating exemplary RFID communication, according to certain embodiments.

FIG. 26 is an exemplary schematic diagram of an RFID reader for use with a landscape controller, according to certain embodiments.

### DETAILED DESCRIPTION

The entire disclosure of U.S. patent application Ser. No. 12/181,894 filed Jul. 29, 2008 of Peter J. Woytowitz et al. entitled IRRIGATION SYSTEM WITH ET BASED SEASONAL WATERING ADJUSTMENT, which was published on Feb. 4, 2010 as US 2010/0030476 A1, is hereby incorporated by reference. The aforementioned U.S. patent application Ser. No. 12/181,894 is assigned to Hunter Industries, Inc., the assignee of the subject application.

It would be highly desirable in the irrigation controller marketplace to be able to modify and/or add to features within an existing irrigation controller to customize the irrigation controller for a particular site. It would also be desirable to meet the changing watering needs of the particular irrigation site by allowing an irrigation controller to be upgraded. The present invention provides a landscape controller that can be easily and economically configured and/or upgraded by the user to meet the specific needs of the associated irrigation site. This is accomplished by installing at least one feature module that communicates with the processor of the landscape controller and alters the operational program, changes a functionality of an operational program executed by the processor, and/or provides additional memory capacity. The term “landscape controller” as used herein refers to a device, which can function as an irrigation controller, and optionally perform additional functions on a site besides watering, such as the control of landscape lights and water features, or which can function as a controller that controls any combination of or any one of the functions of a lighting controller and a water feature controller.

The present invention allows the homeowner or professional to purchase a base controller with only the features needed for his or her particular irrigation site. Features can easily be added at a later date to the installed landscape controller. Landscape controllers can thus be readily and economically tailored to meet the different needs of different sites. Distributors can carry a smaller inventory of controllers and still meet the needs of a wide range of customer demands.

The feature module of the present invention is installed into the control panel portion of the controller that typically contains the processor, display, and manual controls where the user enters watering schedules. The feature module can have various designs to meet particular needs. One form of the feature module is a simple electronic key that enables and/or disables features already programmed into the existing memory of the landscape controller. Another form of feature module provides additional memory, thereby allowing the processor to handle more complex tasks not otherwise capable of being performed by the base controller, such as a memory intensive data logging feature. The feature module may contain new programs that are downloaded into the landscape controller and change the functionality of the operational program executed by the processor, thereby enhancing, adding to and/or otherwise changing the functional irrigation features available to the user, such as providing the capability of modifying watering schedules based on ET data, or optimizing the flow of water through the irrigation pipes. In addition to just changing programming in the controller, the feature module may facilitate expanded communications, e.g. wireless communications with an external rain sensor, a soil moisture sensor, or a weather station, and other capabilities such as controlling a pump relay, landscape lighting, and aesthetic water features such as an electric water fountain. Therefore, instead of using the term “watering program” to refer to the overall program executed by the processor to carry out watering schedules, that code is referred to herein using the term “operational program.” The stored watering program includes a comprehensive set of functional irrigation features and the feature module can be configured to unlock less than all of the functional irrigation features. The feature module and the operational program can be configured so that the feature module can only unlock predetermined functional irrigation features on a predetermined controller and no other controllers. This prevents customers from undercutting the sales of controllers with enhanced features by loaning this feature module to other customers and unlocking the desired features. The feature module can be configured so that the irrigation controller will only execute specified functions so long as that feature module is plugged into the control panel. The feature module can simultaneously unlock certain functional irrigation features stored in the landscape controller and add additional functional irrigation features not found in the firmware originally present in the program memory of the landscape controller. The landscape controller of the present invention can be partially or entirely re-programmed through the feature module years after installation to incorporate many new utilities not previously available on the controller.

The features of the inventive systems and methods will now be described with reference to the drawings summarized above.

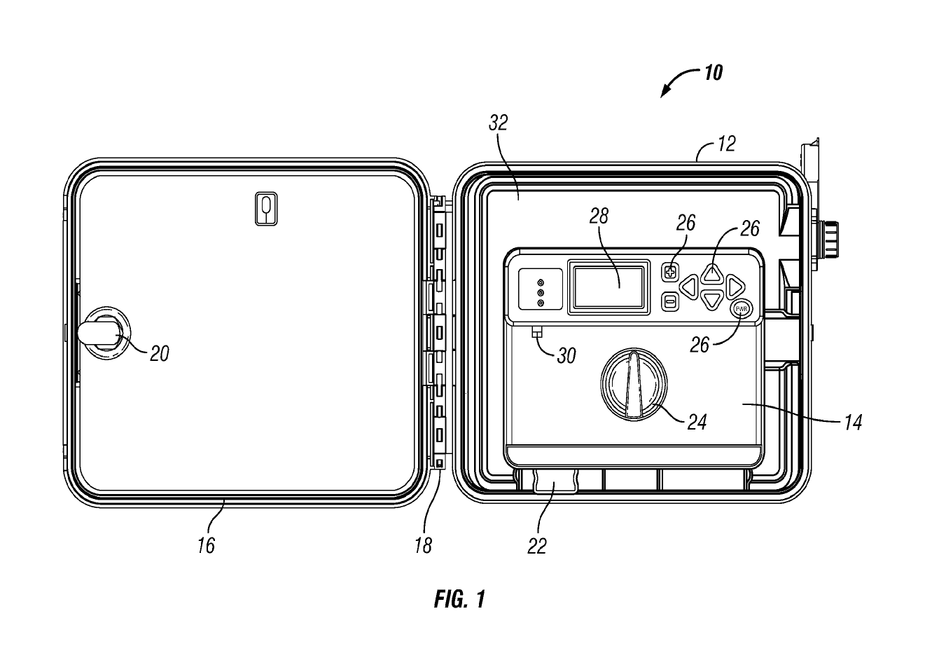

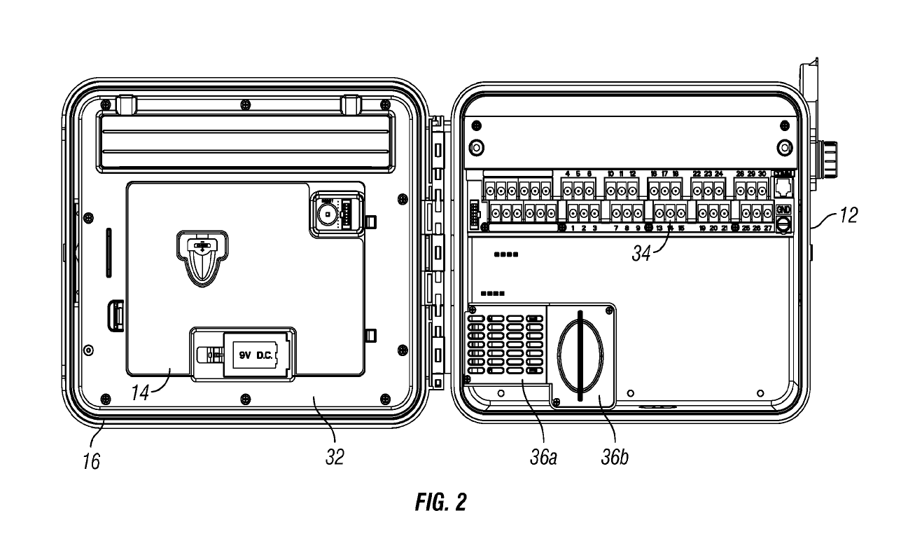

Referring to FIGS. 1 and 2, in accordance with an embodiment of the present invention, a landscape controller 10 includes a rectangular housing or back panel 12 in which a control panel in the form of a face pack 14 is removably mounted. A door 16 mounted on a hinge assembly 18 may be swung closed to seal and protect the face pack 14 and the electronics mounted in the back panel that interact with the face pack 14. The door 16 may be secured in its closed position by actuating a key lock 20 mounted on the door with a key (not illustrated). A feature module 22 is shown plugged into a slot formed in the bottom edge of the face pack 14. The face pack 14 has manual controls that enable a user to enter and/or select a watering schedule, including a rotary switch 24 and seven push button switches 26. The face pack further includes a liquid crystal display (LCD) 28 that provides a graphical user interface (GUI) and a slide switch 30 that enables a user to bypass an optionally installed rain sensor. The face pack 14 is removably mounted in a rectangular receptacle formed in a rectangular frame 32 connected to the hinge assembly 18. The face pack 14 is held in place in the frame by releasable latches (not visible). After the door 16 has been swung to its open position, the frame 32 can be swung to its open position illustrated in FIG. 2, revealing a plurality of screw type wire connectors 34 mounted in the back panel 12 used to connect wires to valves, sensors, lights and pump relays, and other auxiliary devices. A transformer 36a is also mounted in the back panel 12. A wiring enclosure 36b is adjacent to the transformer to provide an area to make wiring connections from the outside power source.

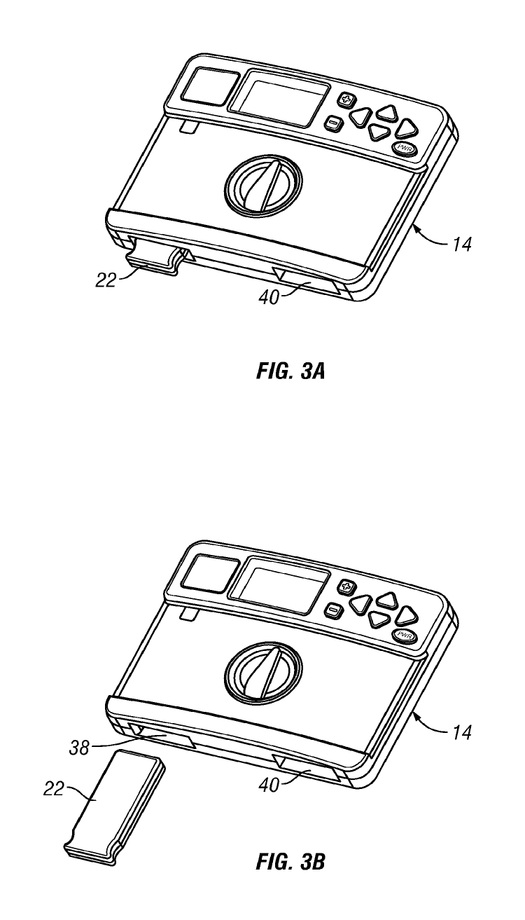

Referring to FIGS. 3A and 3B, various feature modules, such as 22 can be removably inserted in one of two slots 38 and 40 formed in the bottom edge of the face pack 14. The first portion of the connecting device on each feature module is located on the forward end thereof for mating with the second portion of the connecting device, which is located in the end of the slot.

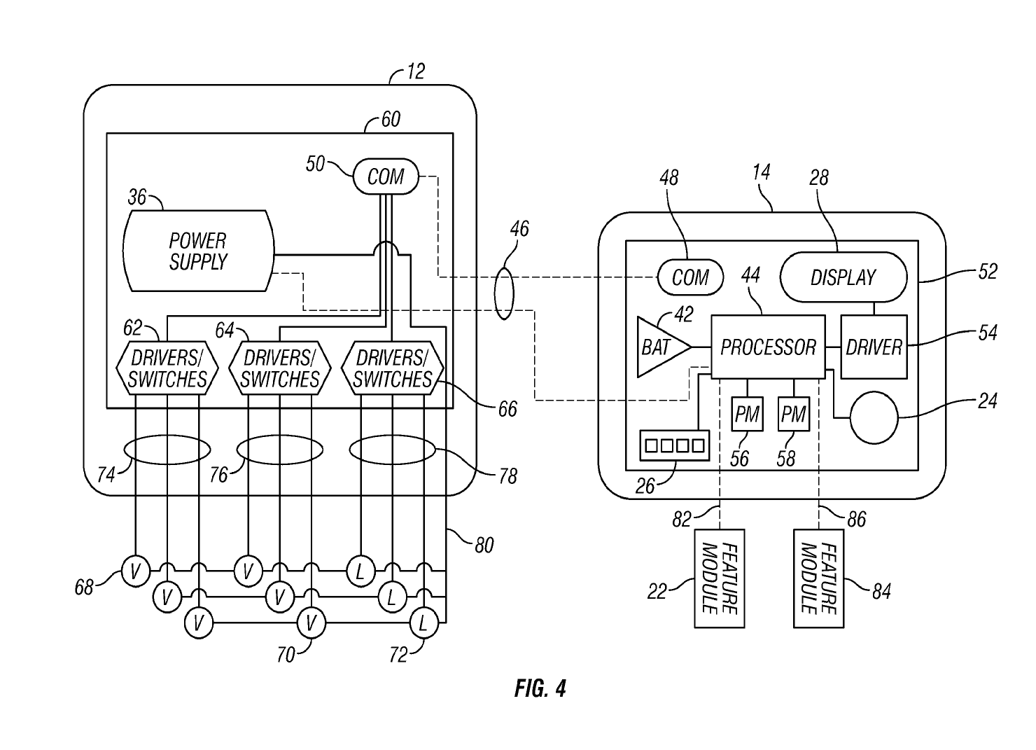

Referring to FIG. 4, the removable face pack 14 includes a portable power source 42 in the form of a battery so that watering schedules can be created or modified when the face pack 14 has been removed from the frame 32 and a person is carrying the face pack 14 around the landscape site. When the face pack 14 is mounted in the frame 32, its processor 44 receives power from the power supply 36 through mating multi-pin electro-mechanical connectors (not illustrated) and a ribbon cable 46 illustrated diagrammatically as dashed lines in FIG. 4. Similarly, when the face pack 14 is mounted in the frame 32, a first communications link 48 in the face pack 14 establishes communications capability with a second communications link 50 in the back panel 12 through the ribbon cable 46. The communications link between the face pack 14 and the circuitry in the back panel 12 could alternatively be established indirectly by suitable means such as mating optical emitter/detector pairs or RF connection. The electronic components of the face pack 14 are mounted on a first printed circuit board 52. A driver 54 mounted on the printed circuit board 52 is connected between the processor 44 and the LCD 28. The processor 44 communicates with a program memory (PM) 56 and a data memory (DM) 58. The processor PM 56 and DM 58 could be provided by a single chip computer.

The back panel 12 houses a second printed circuit board 60 that functions as a so-called “back plane.” The printed circuit board 60 mechanically supports and/or electrically interconnects the second communications link 50, power supply 36 and station control circuitry in the form of driver/switch circuits 62, 64 and 66. The processor 44 executes an operation program, including a watering program that is stored in PM 56 in order to carry out the desired watering schedules and any other functions such as turning landscape lighting ON and OFF. By activating the driver/switch circuits 62, 64 and 66 via communications link 50. The driver/switch circuits 62, 64 and 66 are conventional and may include transistor drivers responsive to ON and OFF commands from the processor 44 that turn triacs ON and OFF to switch low voltage AC power from power supply 36. The driver/switch circuits 62, 64 and 66 control six irrigation valves 68 and 70, and three landscape lights 72 that are connectable to dedicated field lines 74, 76 and 78 and a common return line 80 via screw terminals 34 (FIG. 2). The processor 44 could also control a pump relay (not illustrated) through one of the driver/switch circuits 62, 64, or 66. The power supply 36 is conventional in form and its input is connected to standard 115 or 230 volt AC power and its output supplies the low voltage AC power for the valves 68, 70 and 72, as well as the low voltage DC power required by the electronic components on the printed circuit board 52 in the face pack 14.

Referring still to FIG. 4, the feature module 22 is operatively connected to the processor 44 in the face pack 14 via any suitable connecting device 82 which is illustrated diagrammatically by a phantom line in FIG. 4. These may be male and female multi-pin electrical connectors, card edge connectors, optical connectors or any other suitable connecting devices used in the world of consumer electronics devices with removable components. FIG. 4 illustrates a second removable feature module 84 operatively connected to the processor 44 via a second connecting device 86. The landscape controller of the present invention advantageously operates with feature modules 22 and 84 that are operatively connectable to the processor 44 through a communications path that does not include the backplane 60.

The operational program stored in the PM 56 includes a watering program having all of the features and algorithms necessary to satisfy multiple irrigation controller market segments. The watering program includes scheduling code for sports field application, as well as nursery application. Additional code allows the watering program to make adjustments based on evapotranspiration (ET) data supplied to the processor 44 from a service or from environmental sensors. Different feature modules 22 may be manufactured for installation in the face pack 14 that each enable or activate for usage a predetermined sub-set of a comprehensive set of features capable of being executed by the processor 44. The different feature modules can enable, through unique keys stored on an integrated circuit, different feature sets for different irrigation controller market segments. The most expensive feature module may enable the processor 44 to execute every available feature. Thus, the feature module 22 that is inserted into the face pack 14 enables a predetermined specific set of instructions that implement a comprehensive set of features capable of being executed by the processor 44. In this way, the user only pays for the features needed on his or her particular irrigation site.

Our invention allows a user to buy the base landscape controller 10 and the desired feature set that is enabled by a specific one of several interchangeable feature modules 22. The user can only access a predetermined sub-set of the comprehensive set of features capable of being executed by the processor 44 that are included in the extensive operational program stored in the PM 56 of the face pack. The manufacturer's software engineers only need to write one comprehensive watering program, instead of different watering programs for irrigation controllers targeted at different market segments. Field upgrades can be accomplished by simply purchasing and installing a new feature module 22. Since the feature module is plugged into the face pack 14, all of the authorized functionality of the landscape controller is fully available to the user when the face pack is unplugged from the frame 32 so that the user can walk around the irrigation site, change the water schedule, and make other adjustments.

U.S. Pat. No. 7,257,465 of Perez et al. discloses a modular irrigation controller with a removable face pack. The controller has a number of bays or receptacles in its rear panel into which a plurality of station modules may be individually plugged to increase the number of zones that can be watered. These station modules are not plugged into the removable face pack but are instead plugged into the receptacles so as to allow the station modules to electrically connect to the back plane in the rear panel. So-called “smart” modules can be plugged into these receptacles, such as an ET module or a decoder module, in order to provide additional functionality to the base irrigation controller. However, this irrigation controller architecture suffers from a number of drawbacks. First, each time a smart module is plugged into one of the receptacles in the rear panel, the number of zones that can potentially be controlled is correspondingly reduced since that receptacle is no longer available to receive a station module. Secondly, since the smart modules are not plugged into the face pack, the processor in the face pack may not be able to be programmed using all of the additional functionality provided by the smart modules when the face pack is unplugged from the rear housing. Thirdly, the smart modules disclosed in U.S. Pat. No. 7,257,465 of Perez et al. have no capability for unlocking or enabling otherwise non-available features programmed into the main memory of the base controller. The landscape controller of the present invention overcomes each of these shortcomings.

The primary purpose of an alternate feature module 22 can be the provision of additional memory, or data via that memory, to the face pack 14. For instance, once the processor 44 detects that additional memory has been plugged into the face pack 14, it may enable a memory intensive data logging function not previously possible with the DM 58 in the face pack. Alternatively, the processor 44 may allow more complex programming when there is additional memory available to store more start times, run times, etc. Yet another use of the additional memory is to provide the processor 44 with data. For instance, a memory chip in the feature module 22 may be pre-loaded with historic environmental conditions to allow automatic watering schedule changes. This historic data may be historic average daily ET data for a particular zip code, for example. See U.S. patent application Ser. No. 12/176,936 filed Jul. 21, 2008, the entire disclosure of which is hereby incorporated by reference. A new version of application code may later be developed for the face pack 14. Microcontrollers are currently available for use as the processor 44 that have the ability to write to their own memory (re-flashable). Such a microcontroller can read the information out of the memory in the feature module 22, and re-program itself.

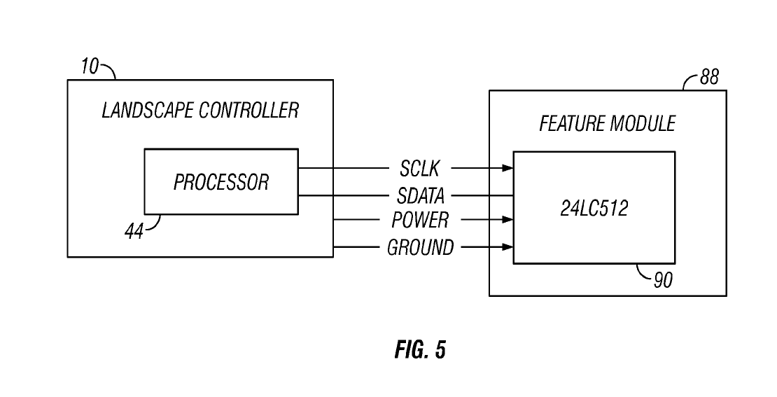

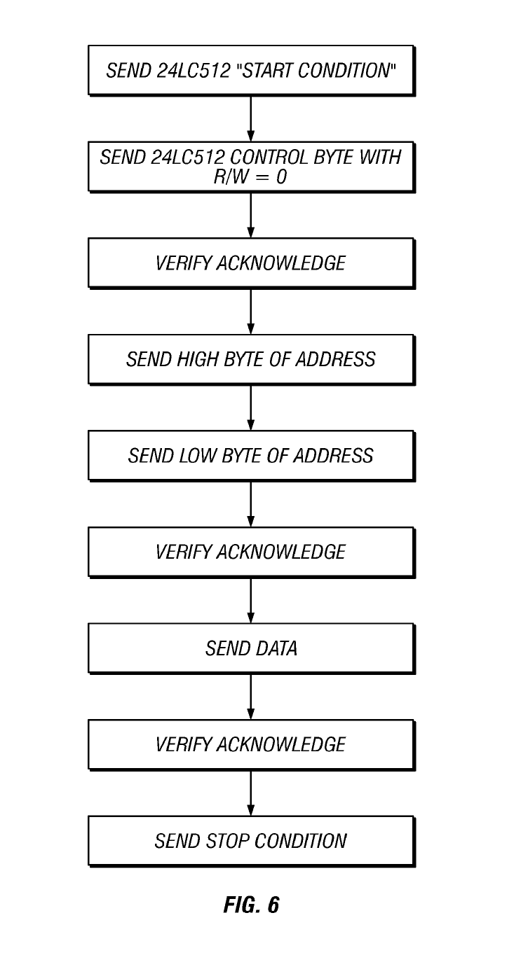

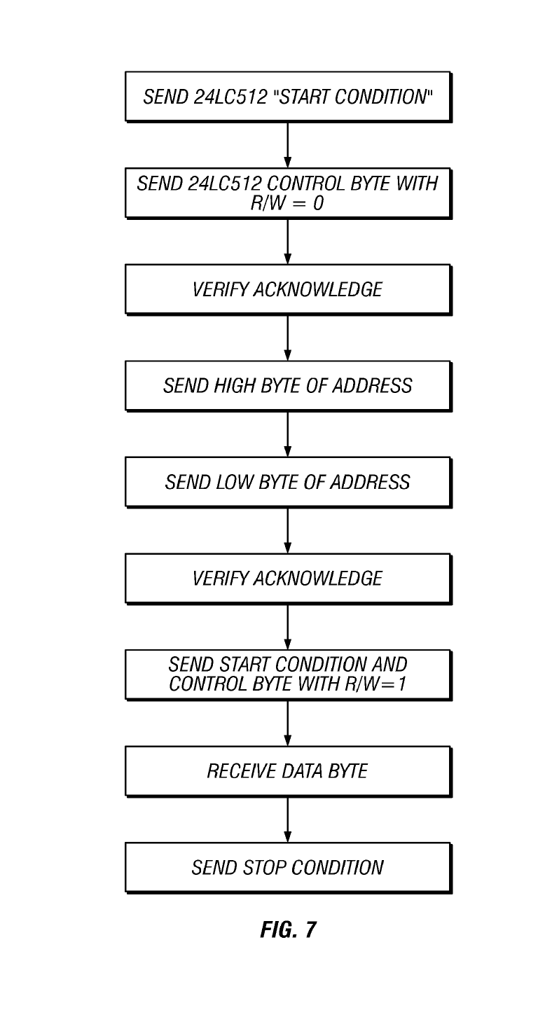

The feature module 22 can contain a variety of different types of memory that can be accessed by the processor 44 in a number of different ways. Serial memory can be accessed with only a few lines. In most cases, these consist of only a clock line, and a data line. There may also be two data lines—one for each direction of data flow. Examples of this type of memory are the 93XX and 24XX industry standards. For instance, the 24LC512 manufactured by Microchip Technology, is a serial, 512 Kbit non-volatile memory chip. The 93LC66, also from Microchip Technology, is a serial, 4 Kbit non-volatile memory chip. An example of how a 24LC512 is configured to work with the host processor (the microcontroller in the landscape controller), is illustrated in FIG. 5. The serial clock (SCLK) and data (SDATA) lines from the feature module 88 allow the processor 44 to exchange command or data information with the memory chip 90 inside the feature module 88. FIG. 6 is a flow diagram illustrating a method of writing a byte of data to the memory chip 90. FIG. 7 is a flow diagram illustrating a method of reading a byte of information from the memory chip 90. The main disadvantage of serial memory is that it is slower to access that parallel memory. However, in most cases, it is sufficiently fast for the purpose of an embedded control device, such as a landscape controller, where most of the reads and writes occur in response to user actions, which by their nature are relatively slow events. Serial memory may be either volatile or non-volatile.

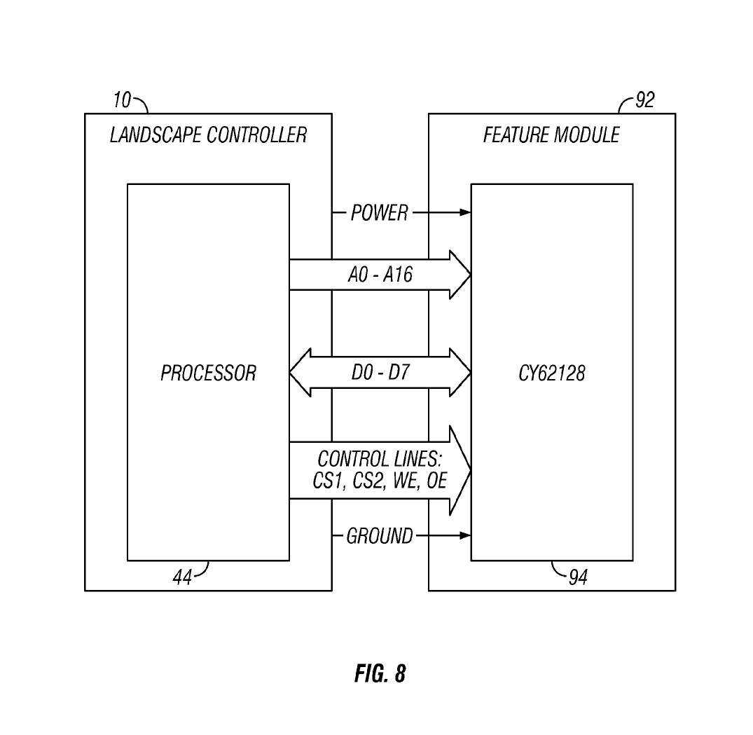

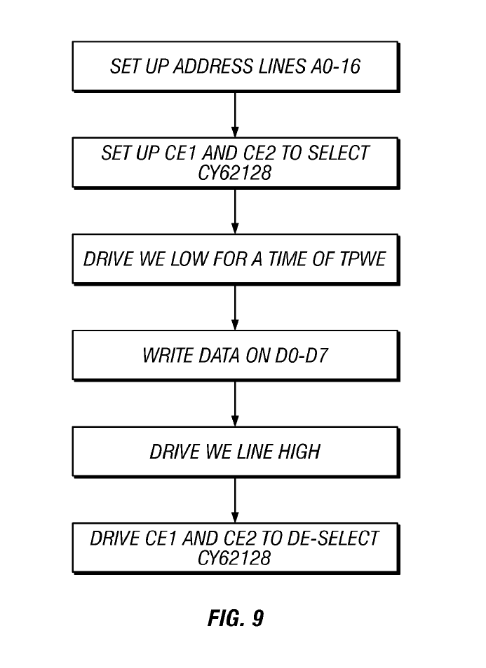

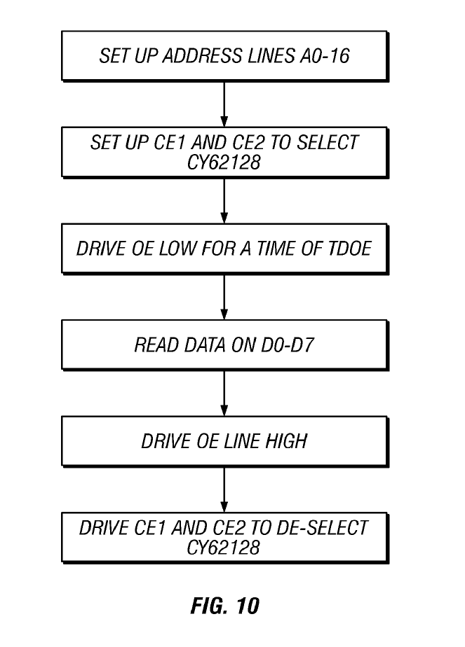

Parallel memory has the advantage that it can be accessed much faster than serial memory. This is because once the address has been set up (all at once), and the chip is enabled, all the data bits appear simultaneously, usually within a few tens or hundreds of nanoseconds. There are usually no clocking operations involved. One example of parallel memory is the CY62128 from Cypress Semiconductor, which is a 128K Byte RAM. An example of how this device can be connected to the processor 44 is illustrated in FIG. 8. The feature module 92 houses a parallel memory chip 94. FIG. 9 is a flow diagram illustrating a method of writing to the parallel memory chip 94. FIG. 10 is a flow diagram illustrating a method of reading from the parallel memory chip 94. Like serial memory, parallel memory may be either volatile, or nonvolatile.

The feature module can be configured as a plug-in memory module that has its own microcontroller on-board. The purpose of this microcontroller is to adapt a memory chip (either serial or parallel) to an industry standard protocol. One example of this is a USB flash or thumb drive. These devices typically have a parallel flash memory chip, such as the Toshiba TC58DVG02A1 connected to a USB-enabled microcontroller such as the Freescale Semiconductor 9S12UF32. The microcontroller manages the implementation of instructions (read/write) over the USB interface, and communicates with the memory chip via its Smart Media Interface. With slightly different firmware, the microcontroller can be adapted to interface to a number of different memory devices, yet the USB interface is standardized.

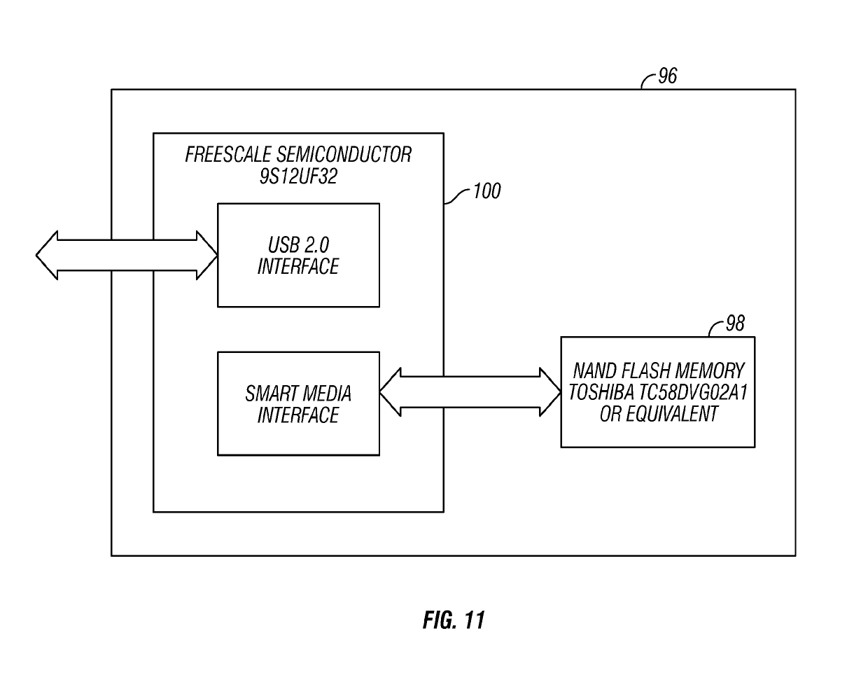

FIG. 11 is a block diagram illustrating a feature module 96 configured like a USB thumb drive. The feature module 96 includes a flash memory 98 and a USB-enabled microcontroller 100. While the feature module 96 includes a USB interface, it should be apparent that this technique can be expanded to cover a variety of physical and protocol layers. For instance, the physical layer may be RS232, or simple TTL level asynchronous data (this is advantageous since most microcontrollers have UART built in that can communicate over such a channel), while the protocol layer may be some proprietary standard. It should also be noted that with onboard intelligence, the data being transmitted to and from the memory module may also be encrypted.

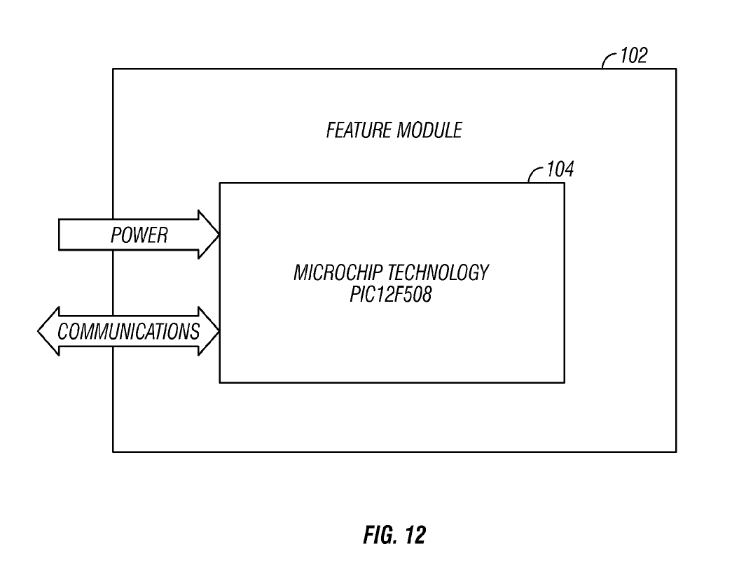

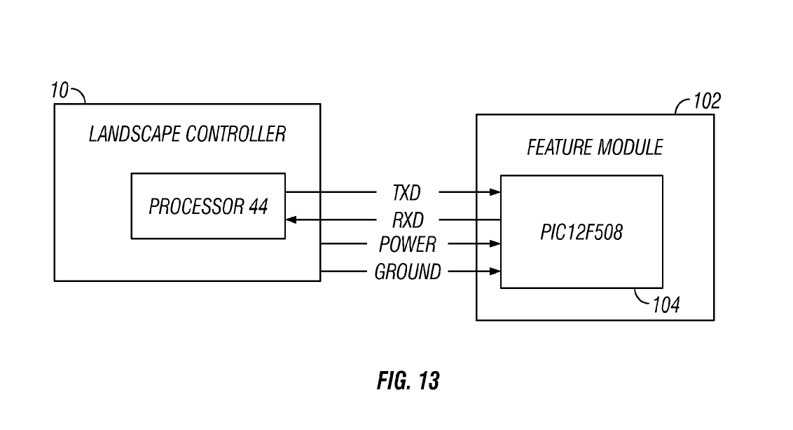

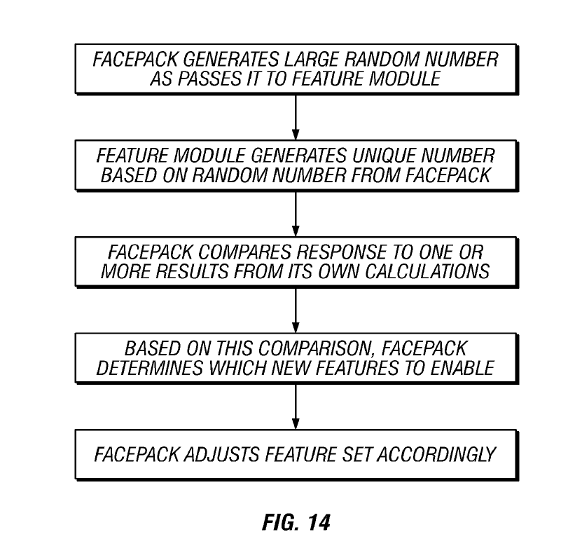

As already explained, a feature module can be inserted to enable more or less functions in the face pack 14. The landscape controller 10 may be sold in a version in which all features already exist in the face pack. In this version, the operational program stored in the PM 56 has all the features that the end user could ever utilize already coded in firmware. When the unit is shipped, some, but not all of these features are active, perhaps for logistic reasons (they may confuse less savvy end users), or for marketing reasons (the end user may be willing to pay more for some features). In either case, the purpose of the feature module 22 is to enable some or all of the features already contained in the face pack code, or to de-feature it. FIG. 12 illustrates a feature module 102 that includes a PIC12F508 microcontroller 104 from Microchip Technology, which incorporates a communication interface to the face pack 14. The feature module 102 may employ a generic asynchronous communication channel as illustrated in FIG. 13, which allows the processor 44 in the face pack 14 to communicate with the microcontroller 104 in the feature module 102 over two data lines, RXD and TXD. The purpose of this communication is to allow the face pack 14 to determine which features to unlock, or to hide. FIG. 14 is a flow diagram illustrating a method of unlocking features pre-programmed into the PM 56 of the face pack 14. Both the face pack code and the feature module code preferably utilize a data encryption algorithm that generates a unique output number for a unique input number. The processor 44 generates a random number of large size and passes this to the feature module 102. The fact that the number is large makes it difficult or impossible to reverse engineer the algorithm because the number of input/output possibilities is too large. The feature module 102 passes this number through its algorithm and generates a unique response. The processor 44 passes the number through one or several algorithms, each corresponding to a different feature, or set of features. The response from the feature module 102 is compared to the results obtained by the processor 44 in the face pack 14, and the appropriate feature set(s) are enabled.

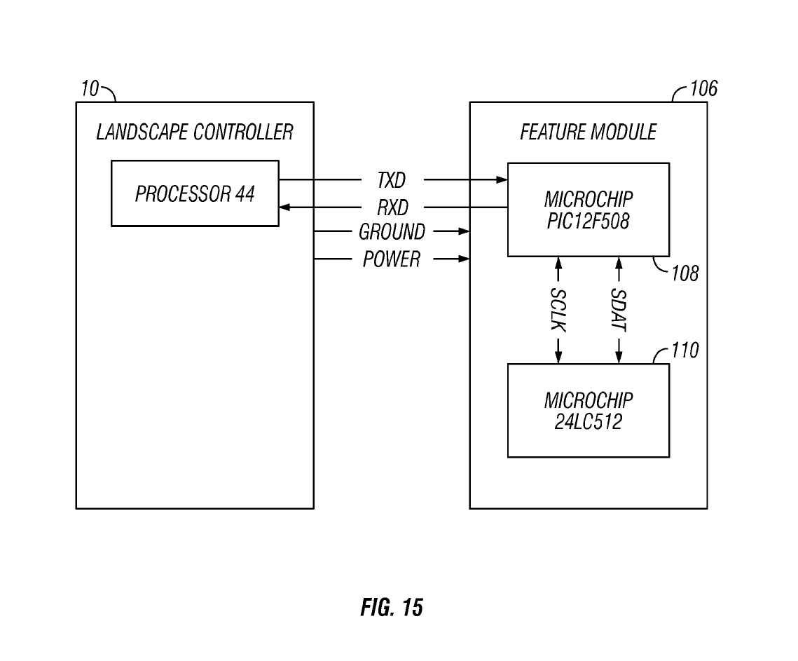

In another version of the landscape controller 10, all of the features are not already programmed into the PM 56 of the face pack 14. In this version of the landscape controller 10, the face pack does not have a particular feature or features that could be added later with a feature module. In order to accomplish this, new operational code must be programmed into the PM 56 of the face pack 14, or otherwise made available to the processor 44. As discussed above, a memory module could hold code that is re-flashed into the face pack 14. However, such a module may be taken to multiple landscape controllers (even if it was only paid for once), and used to re-flash all of them. This limitation can be overcome in several ways. Part of the new application code could be a routine to periodically go out and check for the presence of the memory module, even though its “services” are no longer needed. Another approach is for the microcontroller to actually execute the code out of the module itself. FIG. 15 illustrates a robust feature module 106 that includes two memory components 108 and 110. The feature module 106 receives a key or cipher from the processor 44 in the face pack 14. This key is used as a seed for encrypting data from the feature module 106 to the face pack 14. This encrypted data represents code and instructions and can be an entirely new program which it re-flashes itself with, or it can be a simple code patch. The term “patch” means a portion of code that is patched over an existing program. The patch may modify only a handful of instructions in the code of the operational program stored in the PM 56, or it may replace an entire functional module in the operational program. A patch does not replace the entire operational program, as a full re-flash would accomplish. This new code (patch or entire new operational program) enables features not previously in the operational program of the face pack 14. The processor 44 periodically repeats this process in order to make sure the feature module is still installed.

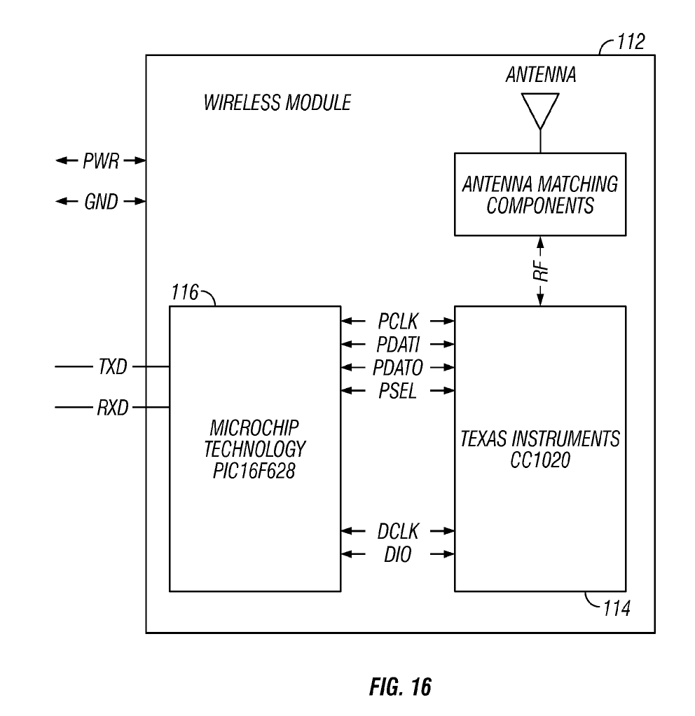

FIG. 16 illustrates a feature module 112 that allows the face pack 14 to communicate wirelessly with other devices. These other devices may range in scope from sensors (rain, wind, temperature, humidity, solar radiation, soil moisture, etc.) to other controllers, or even PC's, Blackberry's, Palm® hand held's, cell phones, and other programing or communication devices. The feature module 112 includes a frequency-agile RF transceiver 114, in the form of the CC1020 transceiver available from Texas Instruments, to communicate with a remote device. A microcontroller 116 in the form of the PIC16F628 microcontroller from Microchip Technology is used to orchestrate the exchange of data between the CC1020 and the processor 44 in the face pack 14. The microcontroller 116 also programs the transceiver 114. There are four connections (PCLK, PDATI, PDATO, and PSEL) between the microcontroller 116 and the transceiver 114 that allow the microcontroller 116 to set up the frequency and operating mode of the transceiver 114. There are two additional connections (DCLK and DIO) that allow data to be exchanged between the microcontroller 116 and the transceiver 114. Depending on the nature of this data, the wireless feature module 112 can communicate with a variety of remote devices. The wireless communications feature module 112 can utilize RF, infrared or other wireless circuitry (receiver or transmitter, or transceiver), that allows a remote device to communicate with the face pack 14.

Another embodiment of the feature module takes the form of a standard secure digital memory card, also known as an SD card that interfaces with the processor in the face pack of the irrigation controller and allows that processor to read and write data files to the SD card. Data files can be stored on the SD card in a number of different forms, providing the irrigation controller with many new features, some of which are briefly described hereafter.
1) An SD card data file can contain a new firmware version for the base irrigation controller. The irrigation controller can read this file and reprogram its program memory, updating its firmware and adding new features or correcting “bugs.”
2) An SD card data file can contain a new watering program for the base irrigation controller. The base irrigation controller can read this file and reprogram the watering schedule, thus allowing a watering schedule to be developed on a personal computer or another irrigation controller and then transferred to the original irrigation controller.
3) An SD card data file can contain a spoken language file. The base irrigation controller can read phrases from this file and write them to the display, substituting them for English phrases. This allows the irrigation controller to support English as well as different foreign languages.
4) An SD card data file can contain an image, which may include a golf course map, an installer's business card, etc. These images can be shown on the display of the irrigation controller.
5) The base irrigation controller can write a log file to the SD card. The SD card file can then be removed and read by a remote personal computer, allowing faults to be debugged remotely from the base irrigation controller.
6) The base irrigation controller can write a file containing an irrigation schedule to the SD card. The SD card can then be removed from the base irrigation controller and plugged into a different irrigation controller so that the file can be read by the second controller, allowing a common watering schedule to be programmed into a plurality of different irrigation controllers.

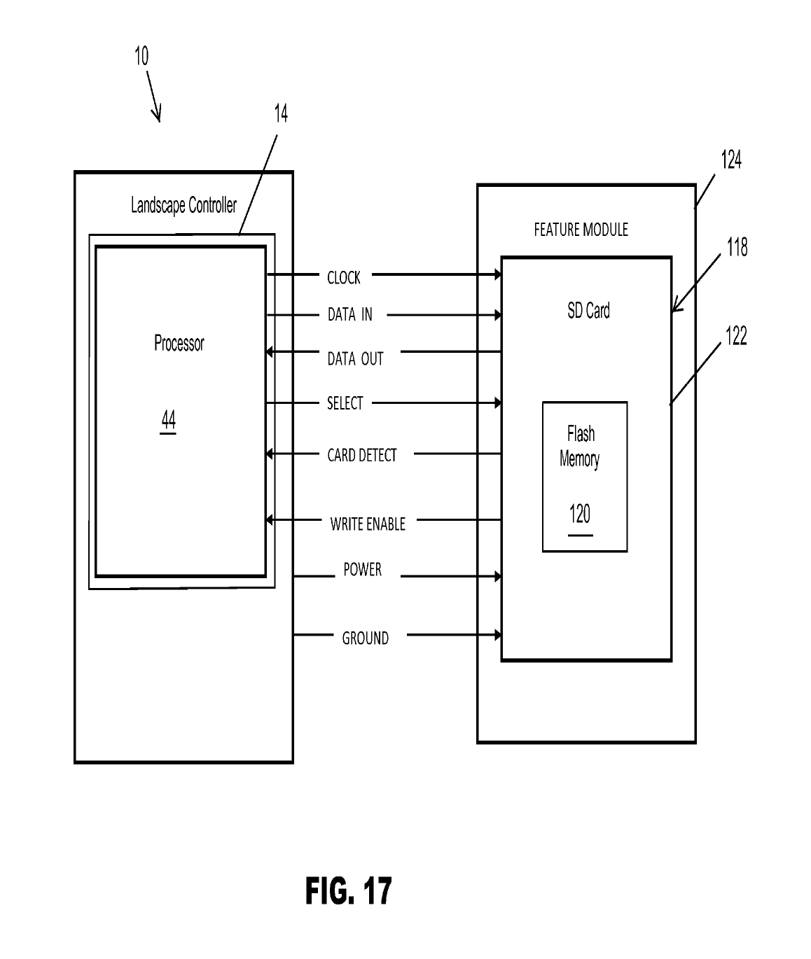

Referring to FIG. 17, the processor 44 in the face pack of the irrigation controller 10 interfaces with a standard SD card 118 via a serial data link. The SD card 118 comprises a flash memory device 120 in the form of an integrated circuit that is physically contained within an outer thin plastic rectangular SD card holder 122 measuring approximately 32 millimeters in length by 24 millimeters in width. In the embodiment illustrated in FIG. 17, the SD card 118 is mounted inside a larger rectangular feature module 124. The SD card holder 122 is physically configured so that when the feature module 124 is plugged into a mating receptacle in the face pack 14 the plurality of discrete male electrical contacts on one end edge of the SD card 118 operatively connect with mating discrete female electrical contacts in the face pack 14 in conventional fashion. The serial data link contains serial clock, serial data in and serial data out lines. A control line to select the SD card 118 is also used together with lines that determine if the SD card 118 is operatively connected to the processor 44, and whether it is write protected. The main memory of the irrigation controller 10 is programmed with firmware that enables exchanges of commands or data between the processor 44 and the SD card 118 over a serial data link. The firmware allows the processor 44 to determine which files are present on the SD card 118, to read and write data to those files, and to create new files as required.

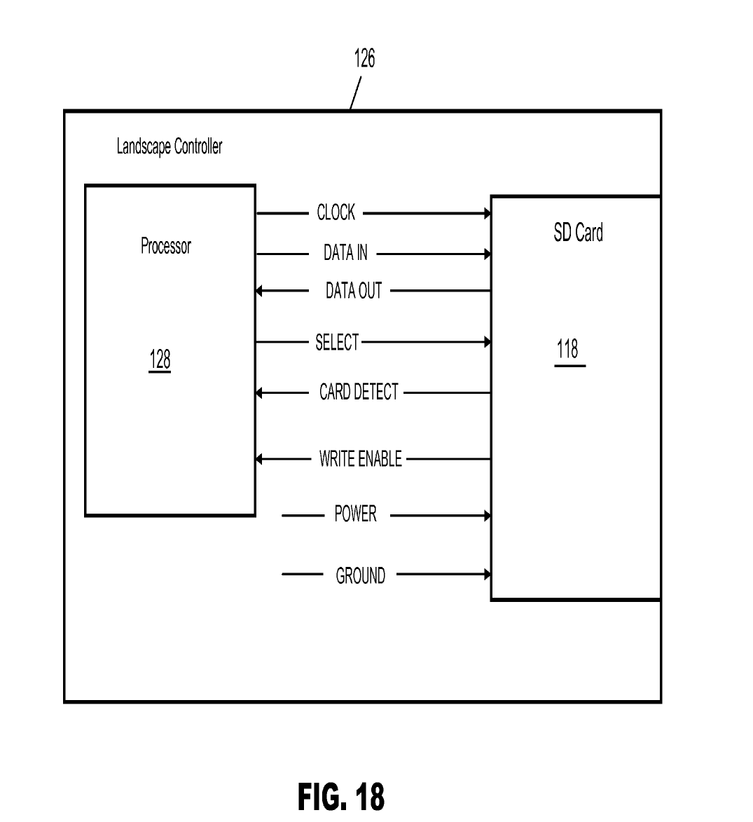

Referring to FIG. 18, the feature module may take the form of the standard SD card 118 itself, without the need for a proprietary outer feature module housing 124 as illustrated in FIG. 17. In the embodiment of FIG. 18, the irrigation controller 126 does not have a removable face pack and instead its main processor 128 is supported on a PC board inside the main housing of the irrigation controller 126. The SD card 118 plugs into a receptacle (not illustrated) in the front panel of the irrigation controller 126 equipped with a standard SD card connector. As with the embodiment of FIG. 17, the main processor 128 (FIG. 18) of the irrigation controller 126 interfaces with the SD card 118 via a serial data link, containing serial clock, serial data in and serial data out lines. A control line to select the SD 118 card is also used together with lines that determine if the card is present, and whether it is write protected. The main memory of the irrigation controller 126 is programmed with firmware that enables exchanges of commands or data between the processor 128 and the SD card 118 over a serial data link. The firmware allows the processor 128 to determine which files are present on the SD card 118, to read and write data to those files, and to create new files as required.

The standard SD card 118 could be in the form of other solid state memory devices commercially available in other industry standard form factors such as the mini SD card and the micro SD card. The standard SD card 118 could also be in the form of other solid-state memory devices with different file systems and data transfer rates such as the SD High Capacity (SDHC) card, the SD Extended Capacity (SDXC) card, and the Ultra High Speed (UHS-I and UHS-II) cards. As used in the claims set forth hereafter, the term “SD card” includes all forms described in this specification as well as other forms of SD cards not specifically described herein and those developed after the filing date of this application.

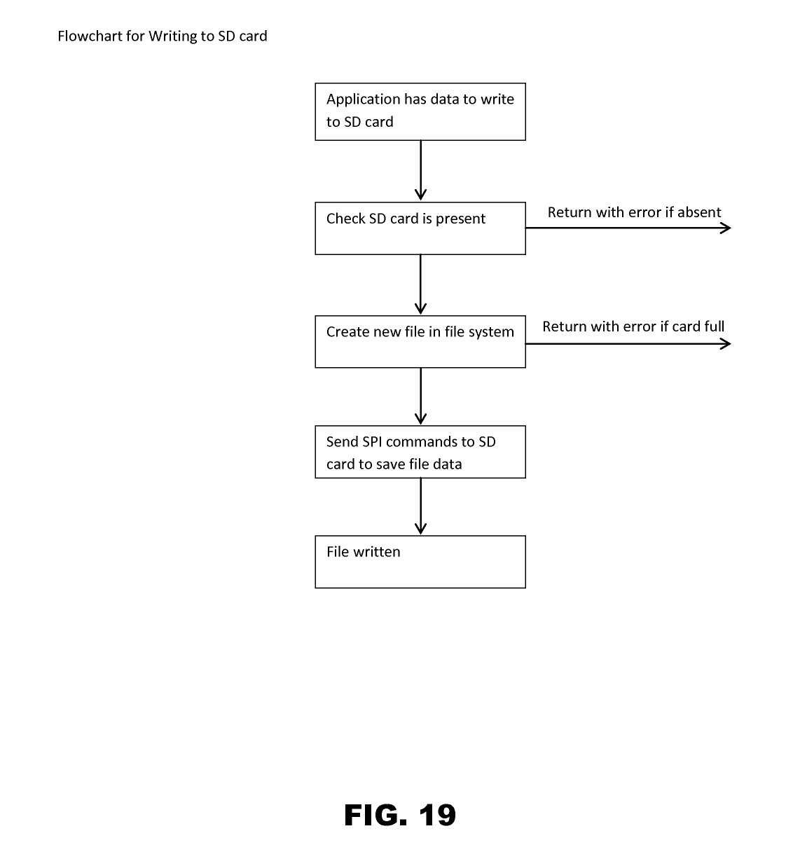

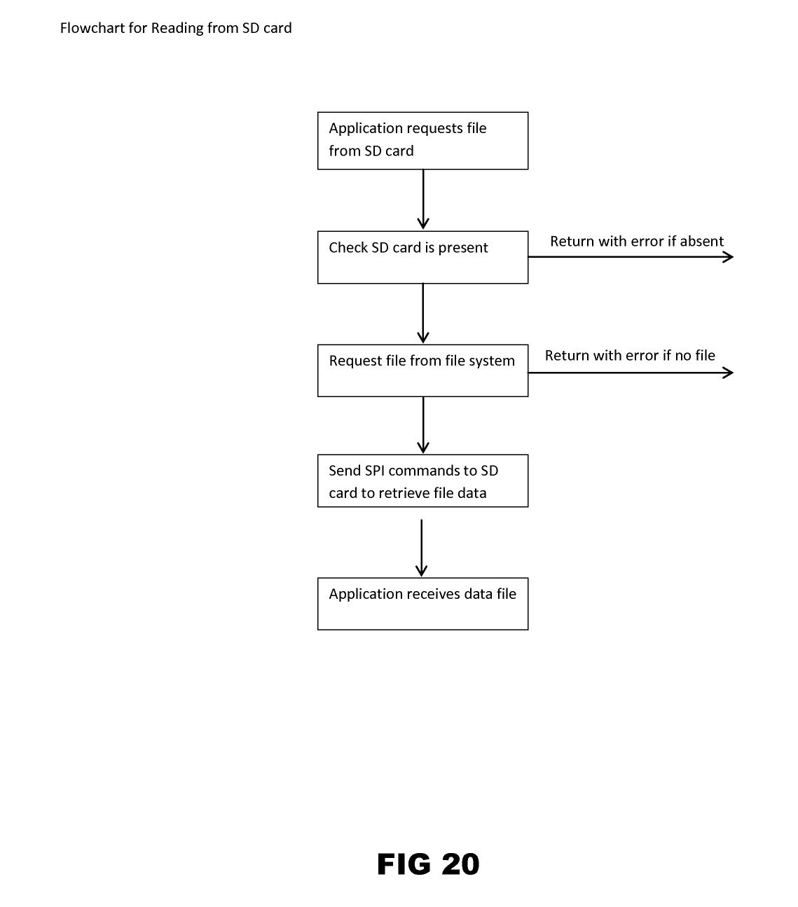

FIG. 19 is a flow diagram illustrating a method of writing a byte of data to the SD card 118. No further explanation is required for persons skilled in the art of designing the electronic and firmware portions of landscape controllers that control irrigation and/or landscape lighting, and other functions. FIG. 20 is a flow diagram illustrating a method of reading a byte of information from the SD card 118. As with the previous figure, no further explanation is required in connection with FIG. 20.

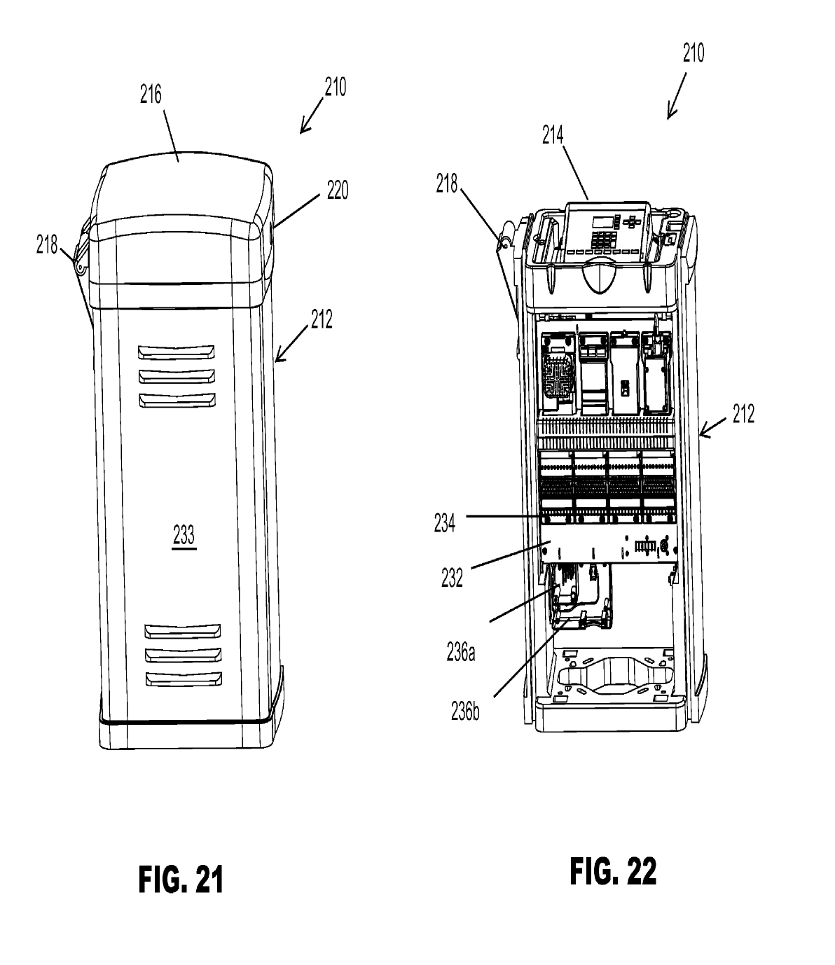

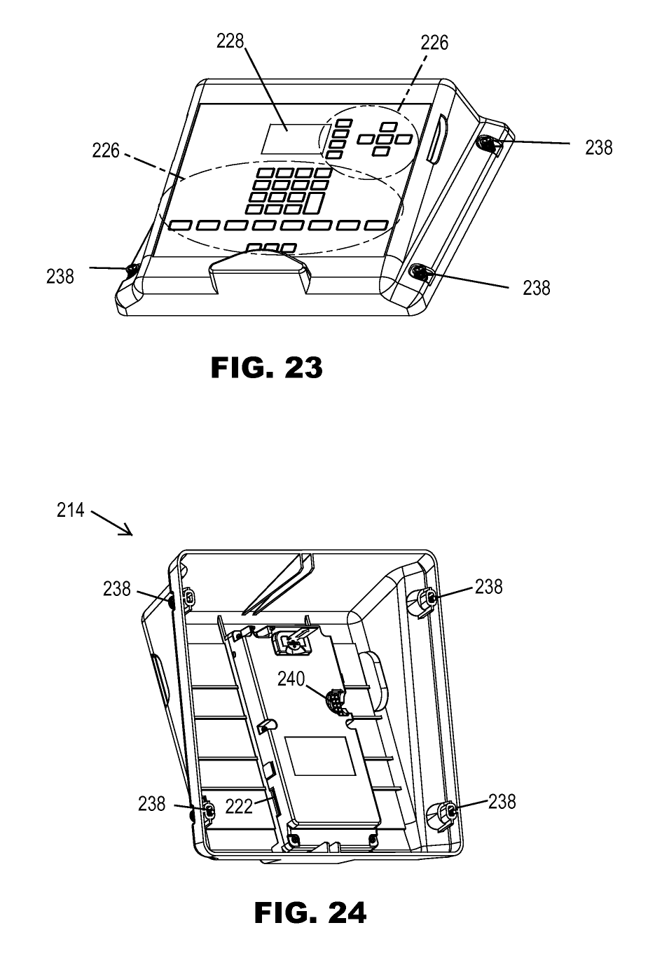

Referring to FIGS. 21 and 22, in accordance with a further embodiment of the present invention, a landscape controller 210 includes a rectangular housing or pedestal 212 in which a control panel in the form of a face pack 214 is removably mounted. A top door 216 mounted on a hinge assembly 218 may be swung closed to seal and protect the face pack 214 and the electronics mounted in the back panel that interact with the face pack 214. The top door 216 may be secured in its closed position by actuating a key lock 220 mounted on the door with a key (not illustrated). The SD card 118 may be plugged into a slot 222 formed in the bottom side of the face pack 214 (FIG. 24) The face pack 214 has manual controls that enable a user to enter and/or select a watering schedule, including several push button switches 226 (FIG. 23) and a liquid crystal display (LCD) 228 that provides a graphical user interface (GUI). The face pack 214 is removably mounted in a rectangular receptacle formed in the upper portion of a rectangular frame 232 of the pedestal 212. The face pack 214 is held in place in the frame by four screws 238 (FIG. 24). After the top door 216 has been swung to its open position, a louvered front panel 233 of the pedestal 212 can be removed as illustrated in FIG. 22, allowing maintenance personnel to gain access to a plurality of screw-type wire connectors 234 mounted on the back panel of the pedestal 212. The screw-type wire connectors 234 may be used to operatively connect wires (not illustrated) that lead to valves, sensors, lights and pump relays, and other auxiliary devices. A transformer 236a is also mounted in the back panel of the pedestal 212. A wiring enclosure 236b surrounds the transformer 236a providing an area to make wiring connections from an outside power source (not illustrated).

Referring to FIG. 24, when the face pack 214 is mounted in the pedestal 212, its processor receives power from the transformer 236a through a mating multi-pin electro-mechanical connector 240 and a wiring harness with a mating connector (not illustrated). Similarly, when the face pack 214 is mounted in the pedestal 212, a first communications link in the face pack 214 establishes communications capability with a second communications link in the back panel of the pedestal 212 through additional wires attached to the mating connector that plugs into the electro-mechanical connector 240.

While several embodiments of a landscape controller with a control panel insertable feature module have been described in detail, persons skilled in the art will appreciate that the present invention can be modified in arrangement and detail. For example, the feature module 84 (FIG. 4) could include the functional equivalent of the ET module circuitry illustrated in FIG. 10 of the aforementioned U.S. patent application Ser. No. 12/181,894. This would enable the processor 44 to communicate with an on-site weather station such as that illustrated in FIGS. 12A, 12B and 13 of that application and use the actual ET data acquired to modify its watering schedules to thereby conserve water. Our landscape controller with control panel insertable feature modules could be configured as a modular controller with a plurality of removable station modules, utilizing an electro-mechanical architecture such as those disclosed in the aforementioned U.S. Pat. No. 6,842,667, U.S. Pat. No. 7,069,115, or U.S. application Ser. No. 12/181,894 filed Jul. 29, 2008, the disclosures of which are incorporated by reference herein. Our landscape controller with control panel insertable feature modules could be configured as a decoder controller with at least one removable or fixed encoder device installed to operate multiple valves through multiple decoder circuits. Where our invention is configured as a modular landscape controller, the controller has a plurality of receptacles for each receiving a removable station module that includes a plurality of switch circuits for energizing a plurality of valves. The station modules can releasably connect to the back plane with multi-pin, card edge or other well-known electro-mechanical connectors used in the electronics industry to establish multi-path mating electrical connections. In the modular controller form of our invention, each feature module is operatively connectable to the processor through a separate connecting device on the control panel that is not associated with a station module receptacle. The feature modules are physically incompatible with the connecting devices in the station module receptacles and are therefore not interchangeable with any of the station modules. Our landscape controller need not include a removable face pack. Instead, the control panel (including the display and at least one manually actuable control for entering or selecting a watering schedule) could be fixed and non-removable relative to the remainder of the controller and include at least one connector-equipped slot or other non-slot mechanism for operatively connecting a feature module.

### RFID Landscape Controller Systems

RFID is an acronym for Radio Frequency Identification. In general, an RFID system comprises at least two devices, such as a two-way radio frequency transmitter-receiver or interrogator, and a transponder. The interrogator is sometimes referred to as the reader, and the transponder is sometimes referred to as the tag. In an embodiment, the reader sends a signal and then detects a response from a tag in proximity to the reader. In general, the nature of the response is a short digital message identifying the tag. In some embodiments, moderate amounts of data can be exchanged between the reader and the tag. In further embodiments, the exchange of data between the reader and the tag can be be-directional.

Tags may be read-only and have a factory-assigned serial number that is used as a key into a database, or may be read/write, where object-specific data can be written into the tag by the system user. Field programmable tags may be write-once, read-multiple; “blank” tags may be written with an electronic product code by the user.

RFID tags comprise at least an integrated circuit for storing and processing information, modulating and demodulating a radio-frequency (RF) signal, collecting DC power from the incident reader signal in some embodiments, and performing other specialized functions; and an antenna for receiving and transmitting the RF signal. The tag information is stored in a non-volatile memory. The RFID tag includes either fixed or programmable logic for processing the transmission and sensor data, respectively.

An RFID reader transmits an encoded radio signal to interrogate the tag. The RFID tag receives the message and then responds with its identification and in some embodiments, other information. Since RFID tags have individual serial numbers, the RFID system, in an embodiment, can discriminate among several tags that may be within the range of the RFID reader and read them simultaneously.

There are a plurality frequencies that can be used by RFID systems to send and receive signals. For example, some common frequencies are shown in Table 1. In other embodiments, other frequencies can be used by the RFID system to send and receive signals.

TABLE 1

| Frequency | | Operating Distance | |
|---|---|---|---|
| 120-150 | KHz | 10 | cm |
| 13.56 | MHz | 1 | m |
| 433 | MHz | 1-100 | m |
| 865-866 | MHz (Europe) | 1-12 | m |

| | |
|---|---|
| 902-928 | MHz (US) |

| | | |
|---|---|---|
| 2.45 GHz, 5.8 GHz | 200 | m |

The operating distances in the table comprise approximations based on the nature of the tags, such as active or passive, the size of the antenna associated with the tag and/or the reader, and other factors. As indicated in Table 1, the range or operating distance between the tag and the reader generally increases with frequency. This is not typically the case for radio frequency (RF) links. However, the nature RFID tags is that they are relatively small and inexpensive. At lower frequencies, in some embodiments, it may be difficult to make an efficient, inexpensive antenna that is also small.

RFID tags, for example, can be either passive, active or battery-assisted passive. A battery-assisted passive (BAP) has a small battery on board and is activated when in the presence of an RFID reader.

Passive RFID tags contain no power source. Instead, the tag derives power from the RF energy transmitted by the reader. Readers that operate with passive tags typically generate strong RF signals to power the tags. For example, to operate a passive tag in one embodiment, it is illuminated with a power level roughly a thousand times stronger than for signal transmission. Additionally, because the tags can only harvest limited amounts of energy from the reader's RF signal, the range of these systems can be limited. In an embodiment, passive RFID tags only operate while in the presence of the reader.

Some passive RFID tags have no electronics, but comprise patterns of metallic material printed on a base material such as paper. The geometry of this pattern is configured such that it has certain resonance frequencies. When interrogating this type of tag, the reader will generate a signal rich in many of the possible frequencies of resonance in the tag, such as a pulse signal, a chirp signal, or the like. The reader then listens for the minute response which will occur only at the resonance frequencies dictated by the tag's pattern. The encoding of the data in the tag is determined by which set of frequencies are returned.

Another method used to communicate with tags that have no electronics is time domain reflectometry. In time domain reflectometry, the reader transmits a pulse of energy, and based on the pattern in the tag, a series of reflections are returned. The data is encoded by the timing of the reflections.

An active RFID tag has an on-board power source, such as a battery, and has the ability to initiate communications. Active RFID tags may require very low power levels from the reader since they do not need to harvest energy, and can typically operate over a larger range than passive tags.

Active RFID tags can also comprise electronic circuits. The electronic circuits may comprise one or more microcontrollers, memory, RF circuits, logic circuits, and the like. Because active RFID tags have a power source, they use the electronic circuits to perform some operations while not being interrogated. These may include logging sensor data, reporting sensor data, broadcasting telemetry data, and the like.

In an embodiment, the active RFID tag comprises memory which can be written to and read by the reader. In another embodiment, the active RFID tag comprises a microcontroller allowing the tag to write to the memory itself, and interface with other circuitry that can be operatively connected to the tag. In an embodiment, the tag can respond with a signal having a different frequency than the frequency of the signal used to interrogate the tag.

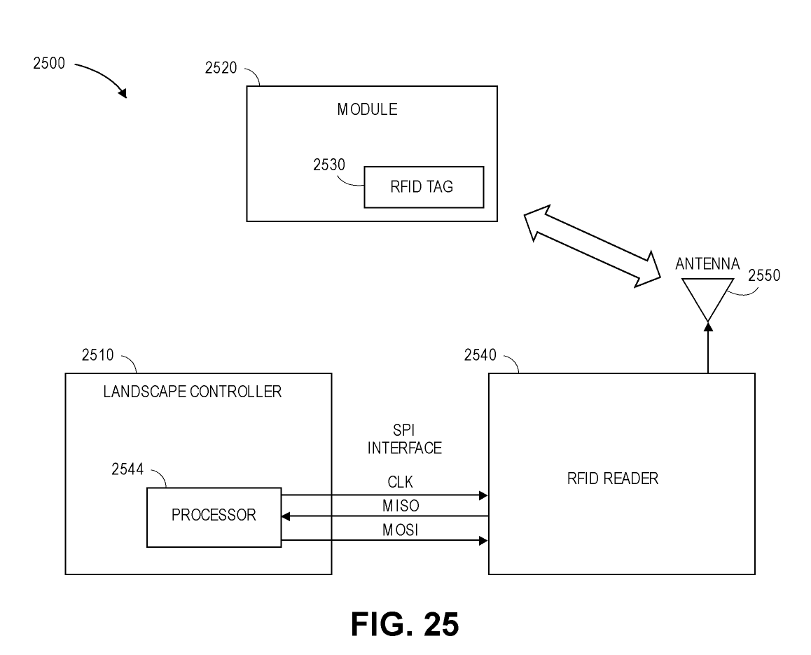

FIG. 25 is a block diagram of an RFID controller system 2500 comprising a controller 2510, an RFID reader 2540 which comprises an antenna 2550 that is configured to send and receive RF signals, and a module 2520 which comprises an RFID tag 2530. In an embodiment, controller 2510 comprises a landscape controller and may control any one of or any combination of irrigation, lights, water features, pumps, etc., as described herein. In an embodiment, the controller 2510 comprises the RFID reader 2540.

In an embodiment, the module 2520 comprises a feature module. In an embodiment, the controller 2510 further comprises the module 2520. In another embodiment, the module 2520 is removably inserted into the face pack of the controller 2510. In a further embodiment, the module 2520 is separate from the controller 2510, or in other words, is not located within the controller 2510, but provides functionality when it is located in proximity to the RFID reader 2540.

The RFID tag 2530 and the RFID reader 2540 communicate via RF signals which are transmitted from or received by the antenna 2550. In an embodiment, the RF communications between the RFID tag 2530 and the RFID reader 2540 is bi-directional. RFID tags 2530 are commercially available. For example, the RFID tag 2530 could be a RI-I16-114A-01 available from Texas Instruments, or the like.

The controller 2510 further comprises a processor or microcontroller 2544, which is operationally connected to the RFID reader 2540 via a Serial Peripheral Interface (SPI) connection. In other embodiments, other interfaces, such as a parallel interface, a serial interface, and the like can be used to provide communications between the microcontroller 2544 and the RFID reader 2540. The microcontroller 2544 is, for example, a PIC18F86K90 available from Microchip Technology, or the like. In another embodiment, the RFID reader 2540 is located in the face pack of the controller 2510, which is typically where the microcontroller 2544 is also located.

The SPI communication protocol designates that one device is a master and the other device is a slave for communication purposes. The master supplies the clock signal for the SPI connection, and therefore controls the timing. The SPI connection comprises at least three signals. The first is the aforementioned clock signal. The second is the serial data from the slave device to the master device (MISO or Master In Slave Out). The third is the serial data from the master device to the slave device (MOSI or Master Out Slave In).

In an embodiment, the microcontroller 2544 communicates with the RFID reader 2540 to periodically search for an RFID tag 2530 within its range. Depending on the type of RFID tag found and the data returned, features associated with the feature module 2520 can be enabled. Examples of features are Feature Unlocking, User Privileges, New Feature Enablement, Module Authentication, Module Inventory, and the like.

### Feature Unlocking

In an embodiment, the code or firmware for the feature already exists in the controller 2510 and is “unlocked” by the RFID Tag 2530 which is installed in the controller 2510. The RFID tag 2530 functions as a key and the controller 2510 periodically checks to see that the key has not been removed. In an embodiment, when the RFID tag 2530 is removed from the controller 2510, the feature no longer operates.

### User Privileges

In an embodiment, certain users are issued RFID tags 2530 that act as a key to unlock certain privileges in the controller 2510 when the RFID tag 2530 is in the proximity of the controller 2510. For example, the RFID tag 2530 could be part of a key chain issued to the user. A maintenance contractor, for instance, may not be issued an RFID tag 2530, and therefore he can only start/stop manual irrigation, whereas a supervisor does have the RFID tag 2530 and can make schedule and setup changes to the controller 2510.

### New Feature Enablement

In an embodiment, the RFID Tag 2530 comprises onboard memory, which can be read by the controller 2510 via the RFID reader 2540. This memory may comprise code patches or new code, which provides new or additional functionality in the controller 2510.

### Module Authentication

A challenge associated with modular products, such as feature modules 2520, is that third party suppliers often produce “compatible” replacement modules using substandard designs and parts, and sell them for less. An RFID tag 2530 embedded into the feature module 2520 could be used to authenticate the feature module 2520. In an embodiment, the controller 2510 would not recognize unauthenticated feature modules.

### Module Inventory

In an embodiment, the controller 2510 via the RFID reader 2540 queries the modules 2520. Based on receiving a response, the controller 2510 determines the quantity of installed modules 2520. Based on the response returned from the modules 2520 via the RFID tag 2530, the controller 2510 determines the types of installed modules 2520.

### Health/History Log

In another embodiment, the RFID reader 2540 sends data to the RFID tag 2530 to be stored in the RFID tag 2530. For example, the controller 2510 could maintain a Health/History Log of the installed modules 2520.

In an embodiment, the RFID tag 2530 comprising read/write memory could be installed inside the module 2520 where the read/write memory comprises information about the use of the module 2520. Because the RFID tag 2530 is not electrically connected to the controller 2510 or other circuitry in the module 2520, the RFID tag 2530 is relatively immune to the effects of lightning and surge that can damage controllers 2510 and modules 2520. Therefore, the memory in the RFID tag 2530 can be written with information, such as the date of manufacture, whether the module 2520 passed factory acceptance testing, the number of times the module 2520 was actuated, the date and conditions when the controller 2510 could no longer communicate with the module 2520 in the event of a failure, and the like. Even if the primary electronic circuitry in the module 2520 were damaged, the RFID tag 2530 could still be read and provide clues to what caused the failure and how to design better products in the future.

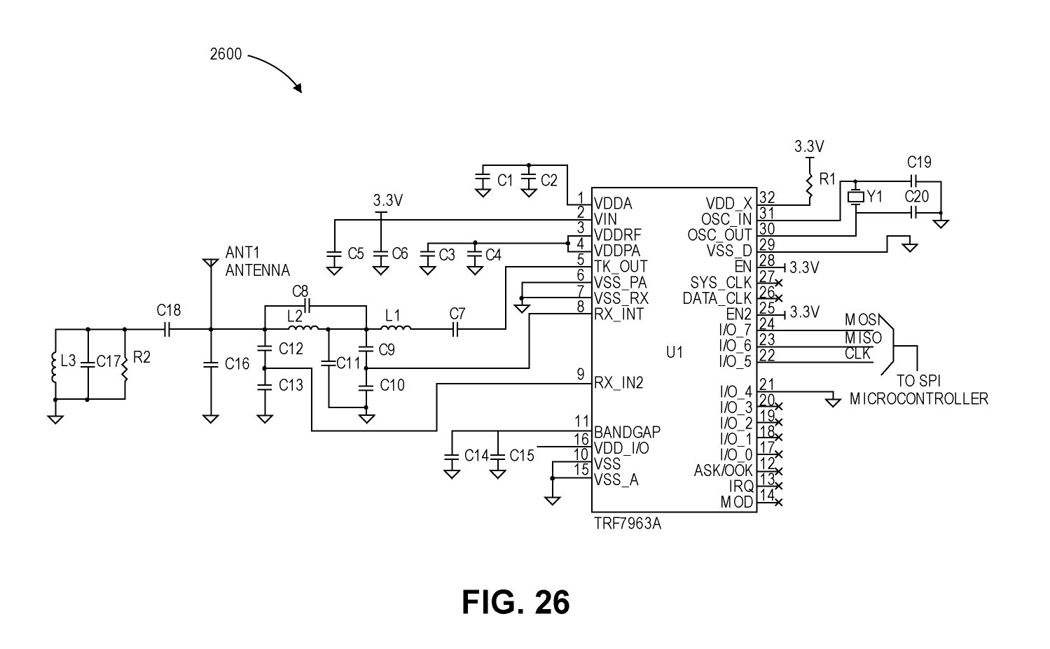

FIG. 26 is an exemplary schematic diagram of an RFID reader 2600 comprising an RFID reader integrated circuit (IC) U1. The RFID reader IC U1 is, for example, a TRF7963A available from Texas Instruments, or the like.

In the illustrated embodiment of FIG. 26, the RFID reader 2600 further comprises capacitors C1-C20, inductors L1-L3, a crystal oscillator Y1, resistors R1-R2, and an antenna ANT1. The TRF7963A is powered by an approximately 3.3V logic power supply. In an embodiment, this is the same power supply as the host controller 2510 uses to power its logic circuitry. In other embodiments, other logic power supplies can be used to power the RFID reader 2600.

The crystal oscillator Y1 provides a time-base for the RF signals used by the RFID controller system 2500. In an embodiment, the crystal oscillator Y1 has an approximately 13.56 MHz frequency and is used as the time-base for the approximately 13.56 MHz RF signals. Capacitors C1-C6, C14-C15 are decoupling and bypass capacitors, which assure that the TRF7963A, has a clean power supply. Capacitors C7-C13 and inductors L1, L2 are matching components configured as a matching circuit to match the impedance of the antenna ANT1 to the input and output impedances of the RFID reader IC U1. In an embodiment, the antenna ANT1 comprises a 50-ohm antenna. Resistor R2, inductor L3, and capacitor C17 comprise a parallel tuned circuit to decrease spurious outputs in transmit mode and filters spurious inputs in receive mode.

As described herein, there are numerous types of RFID systems. It is possible that newer, higher frequency systems will be developed. The embodiments presented herein comprise examples of how an RFID system could be incorporated with feature modules 22, 88, 92, 96, 102, 106, 112, 2540 and landscape controllers 10, 2510. Further, Feature Unlocking, User Privileges, New Feature Enablement, Module Authentication, Module Inventory, Health/History Log are just some of the benefits that can be achieved by incorporating RFID systems into the feature modules 22, 88, 92, 96, 102, 106, 112, 2540 and landscape controllers 10, 2540. Other embodiments and other benefits can be achieved without departing from the spirit of the disclosure.

### TERMINOLOGY

Depending on the embodiment, certain acts, events, or functions of any of the algorithms described herein can be performed in a different sequence, can be added, merged, or left out (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding whether these features, elements, and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. An irrigation system comprising:
a back plane housed by a housing;
a control panel mounted to the housing and configured to enable a user to enter and/or select a watering schedule, the control panel comprising a memory configured to store an operational program that implements the watering schedule and a processor configured to execute the operational program;
at least one feature module configured to provide additional functionality not available without the at least one feature module, the at least one feature module comprising a radio frequency identification (RFID) tag configured to provide tag information;
an RFID tag reader configured to read the RFID tag and to communicate the tag information to the processor, wherein based at least in part on the tag information, the processor implements the additional functionality; and
station control circuitry configured to selectively energize a plurality of valves to deliver water to sprinklers according to the watering schedule, the station control circuitry further configured to be removably insertable on the back plane.

2. The irrigation system of claim 1 wherein the processor controls the RDIF tag reader.

3. The irrigation system of claim 2 wherein the reader periodically reads the RFID tag to determine whether the feature module has been removed from a reading range of the RFID tag reader.

4. The irrigation system of claim 1 wherein the RFID tag comprises memory that stores the tag information.

5. The irrigation system of claim 1 wherein the tag information comprises executable code configured to be executed by the processor.

6. The irrigation system of claim 1 wherein the tag information comprises authentication information to authenticate the feature module.

7. The irrigation system of claim 1 wherein the RFID tag reader is further configured to query one or more RFID tags associated with the control panel, and based at least in part on the responses returned from the one or more RFID tags, the processor determines types of the feature modules.

8. The irrigation system of claim 1 wherein the RFID tag comprises read/write memory and the RFID tag reader is configured to send data to the RFID tag to be stored in the read/write memory.

9. The irrigation system of claim 8 wherein the data comprises use information about a use of the at least one feature module.

10. A method to control a plurality of valves on an irrigation site, the method comprising:
accepting inputs on a control panel from a user that enable the user to enter a watering schedule;
storing the watering schedule in memory that is operatively connected to a processor configured to execute the watering schedule;
providing a feature module that comprises a radio frequency identification (RFID) tag and a housing configured to house the RFID tag, the feature module configured to provide additional functionality not available without the feature module;
reading the RFID tag to obtain tag information;
determining, based on the tag information, whether to access the additional functionality provided by the feature module; and
selectively turning a power signal ON to a plurality of valves that deliver water to a plurality of sprinklers located on an irrigation site according to the watering schedule.

11. The method of claim 10 wherein reading the RFID tag comprises reading the RFID tag with an RFID tag reader when the RFID tag is within a reading range of the RFID tag reader.

12. The method of claim 10 further comprising communicating the tag information to the processor.

13. The method of claim 12 wherein the processor and the RFID tag reader communicate over a serial peripheral interface (SPI) connection.

14. The method of claim 10 wherein the additional functionality comprises one or more of a feature unlocking function, a user privilege, a new feature enablement function, a module authentication function, a module inventory function, and a health/history log.

15. A landscape controller comprising:
a housing;
a control panel associated with the housing and including at least one manual control that enables a user to enter and/or select a watering schedule;
a memory storing an operational program to implement the watering schedule;
a processor configured to execute the operational program;
a radio frequency identification (RFID) tag reader configured to read tag information from an RFID tag when the RFID tag is near the RFID tag reader, the RFID tag associated with a feature module that provides additional functionality not available without the feature module, the RFID tag reader further configured to communicate the tag information to the processor, wherein based at least in part on the tag information, the processor accesses the additional functionality provided by the feature module; and
station control circuitry controlled by the processor that enables the processor to selectively energize a plurality of valves to deliver water to sprinklers according to the watering schedule.

16. The landscape controller of claim 15 wherein the operational program includes a set of features capable of being executed by the processor and the additional functionality of the feature module enables a sub-set of the set of features.

17. The landscape controller of claim 15 wherein the feature module further comprises additional memory that enables the processor to execute at least one feature when the additional functionality is accessed that is otherwise not executable by the processor.

18. The landscape controller of claim 15 wherein the operational program comprises at least one locked irrigation feature.

19. The landscape controller of claim 18 wherein the processor is configured to unlock the at least one locked irrigation feature based at least in part on the tag information.

20. The landscape controller of claim 15 wherein the station control circuitry comprises an encoder that transmits operational instruction to decoders that are installed outside of the landscape controller.
